(19) United States
(12) Patent Application Publication
(10) Pub. No.: US 2019/0084136 A1
(43) Pub. Date: Mar. 21, 2019

(54) TOOL SYSTEMS FOR FORMING SEALED CONNECTIONS

(71) Applicant: Ridge Tool Company, Elyria, OH (US)

(72) Inventor: Richard M. Kundracik, Elyria, OH (US)

(21) Appl. No.: 15/711,582

(22) Filed: Sep. 21, 2017

(51) Int. Cl. B25B 27/10; B21D 39/04

(52) U.S. Cl. CPC B25B 27/10; B21D 39/046; B21D 39/048

(57) ABSTRACT

Tool systems for forming sealed connections are described. The tool systems include a pivoting jaw assembly and one or more insertable die sets that are received, positioned between, and engaged with the jaws of the jaw assembly. Examples of the die sets include clinch-type die sets and radial press die sets. Also described are methods of using the tool systems and die sets.

### FIELD

The present subject matter relates to tool systems for forming sealed connections, die sets for use with the tool systems, and various methods of use relating to the tool systems and/or die sets.

### BACKGROUND

Crosslinked polyethylene tubing (PEX) is widely used in plumbing applications for carrying potable water. In such systems, connections are typically made using fittings that are crimped in place by a crimp tool. Most fitting systems are radial press systems. A seal is created by inwardly compressing the PEX tubing over a barbed male component or other component such as a union, T-adapter, manifold, or valve. A ring or sleeve positioned over the tubing and permanently deformed around the entire circumference of the tubing using the crimp tool to create a compressive seal between the tubing and the component. Thus, the crimp tool engages the ring radially and the crimp profile formed in the ring results from the tool. An example of these systems are those that satisfy the ASTM F1807 crimp standard.

Other fitting systems are available that use a clinch clamp ring instead of a radially pressed ring. In these clinch-type systems, the clamp ring once placed over the tubing, is clinched or permanently deformed at one location along its circumference thereby causing radial tension in the ring around its entire circumference. This action results in a compressive seal between the tubing and the component. Such a system from Oetiker is known. Typically, an entirely different and separate clinch tool is used for these systems.

Although satisfactory in many respects, it would be desirable to utilize a single tool or tool system that could form sealed connections from different types of sealing rings. In particular, it would be beneficial to provide a tool system that could be used with both radial press systems and clinch-type systems.

### SUMMARY

The difficulties and drawbacks associated with previous approaches are addressed in the present subject matter as follows.

In one aspect, the present subject matter provides a tool system comprising a pivotally positionable jaw assembly including a first jaw and a second jaw. The jaw assembly is positionable between an opened position and a closed position. The tool system also comprises a clinch-type die set adapted for placement and engagement between the first jaw and the second jaw. And, the tool system comprises a radial press die set adapted for placement and engagement between the first jaw and the second jaw.

In another aspect, the present subject matter provides a tool system comprising a tool having an actuator, and a jaw assembly including a first jaw and a second jaw. The first jaw and the second jaw are positionable between an opened position and a closed position. The tool system also comprises a radial press die set adapted for placement and engagement between the first jaw and the second jaw. The tool system additionally comprises a clinch-type die set including a first movable member and a second movable member. Each of the first and second movable members define a clinch member at a distal end of a corresponding movable member. The die set is adapted for placement and engagement between the first jaw and the second jaw. Upon placement and engagement of the clinch-type die set with the jaw assembly, and positioning the first and the second jaws to the opened position, the clinch members are spaced apart from each other. And upon positioning the first and the second jaws to the closed position, the clinch members are spaced apart from each other by a closure span.

In yet another aspect, the present subject matter provides a method for forming a sealed connection between flexible tubing and a component. The method comprises providing a tool system including (i) a pivotally positionable jaw assembly including a first jaw and a second jaw, (ii) a clinch-type die set adapted for placement and engagement between the first jaw and the second jaw, and (iii) a radial press die set adapted for placement and engagement between the first jaw and the second jaw. The method also comprises identifying an end of the flexible tubing to be sealingly connected to the component. The method further comprises selecting one of (i) a clinch-type fitting ring and (ii) a radial press fitting ring. The method additionally comprises positioning the end of the tubing over the component to which the tubing is to be sealingly connected. The method also comprises placing the selected fitting ring over the tubing at or proximate the end of the tubing. The method additionally comprises selecting one of the die sets of the tool system based upon the selection of the fitting ring. And, the method comprises engaging the selected die set with the jaw assembly of the tool system. If the selected fitting ring is a radial press fitting ring, the selected die set is the radial press die set, and the method further comprises positioning the jaw assembly and radial press die set such that the radial press die set is disposed about the radial press fitting ring, and urging the jaw assembly toward a closed position whereby the radial press fitting ring is deformed about the tubing to thereby form the sealed connection. If the selected fitting ring is a clinch-type fitting ring, the selected die set is the clinch-type die set, and the method further comprises positioning the jaw assembly and clinch-type die set such that the clinch-type die set is engaged with the clinch-type fitting ring, and urging the jaw assembly toward a closed position whereby the clinch-type fitting ring is tensioned about the tubing to thereby form the sealed connection.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 illustrates a user holding an embodiment of a tool in accordance with the present subject matter, and depicts the tool and its jaw assembly.

FIG. 2 is a schematic illustration of the jaw assembly of the tool of FIG. 1 showing the jaws in an open position.

FIGS. 3 to 6 illustrate the jaw assembly of the tool of FIG. 1 and placement and engagement of a clinch-type die set therein in an embodiment of the present subject matter.

FIGS. 7 to 10 illustrate the jaw assembly of the tool of FIG. 1 and placement and engagement of a radial press die set therein in an embodiment of the present subject matter.

FIGS. 11-12 are schematic side views of the jaw assembly of the tool of FIG. 1 showing a particular embodiment of a clinch-type die set and a clinch-type fitting ring.

FIGS. 13-14 are schematic side views of the jaw assembly of the tool of FIG. 1 showing a radial press die set and a radial press fitting ring.

### DETAILED DESCRIPTION OF THE EMBODIMENTS

The subject matter under review relates to tool systems that include a crimp or press tool with a pivoting jaw assembly and one or more insertable die sets that can be used with the tool to crimp, deform, or clinch a variety of fittings. One die set is configured for “clinching” or applying a tangential compressive force to a circumferential workpiece or fitting. This type of die set is referred to herein as a “clinch-type” die set. The clinch-type die set is also configured to be fittingly received within the work region of the tool. Clinch-type sealing rings such as those which are used with Oetiker sealing systems are well known in the art and are described for example in U.S. Pat. Nos. 2,614,304 and 3,082,498. Such sealing rings are typically in the form of a closed or continuous ring having one or more radially projecting “ears.”

Upon placement of the ring over tubing or other flow member(s) and compressing one or more of the ears by use of the die set to thereby deform the ear, radial tension is created in the ring which forms and maintains a sealed connection between the tubing and the component.

Another die set is configured for “radially pressing” or applying a radially compressive force to a circumferential workpiece or fitting. This type of die set is referred to herein as a “radial press” die insert. The radial press die insert is also configured to be fittingly received within the work region of the tool. Radial press sealing rings are typically in the form of a closed or continuous ring, free of any ears or other radial projections. The rings are radially compressed about the tubing or flow member(s) to such an extent that the ring is permanently deformed in place to thereby maintain a sealed connection between the tubing and component.

The tool systems enable an operator to use a single tool to crimp fittings that receive radial forces such as PEX fittings and clinch fittings that receive tangential forces such as Oetiker fittings.

In many embodiments, the tool systems of the present subject matter may include (i) a tool, which can for example be in the form of a press tool, having an actuator assembly with a displaceable ram and a jaw assembly that is positionable between a fully opened position and a closed position, and one or both of (ii) a radial press die set and/or (iii) a clinch-type die set. In many embodiments, the actuator assembly includes a roller screw assembly which is driven by an electric motor. In certain embodiments, the tool systems include the jaw assembly and one or both of the noted die sets and may optionally include the noted actuator assembly if the jaw assembly is releasably engageable with the actuator.

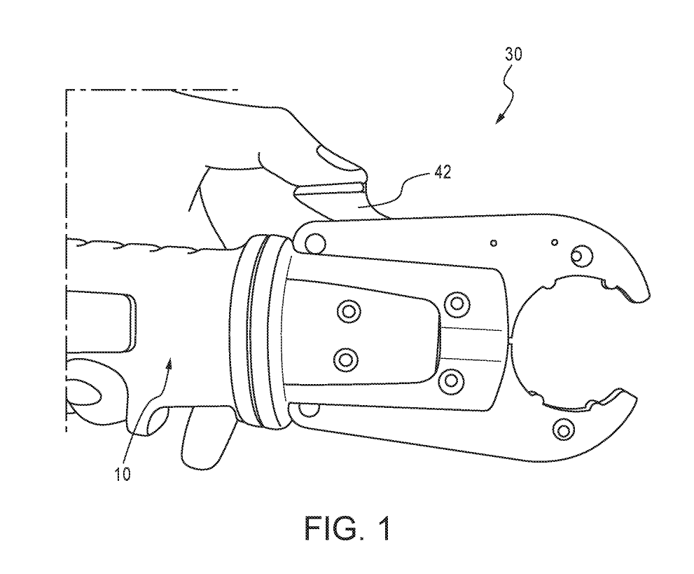

The tool is typically electrically powered and in many embodiments utilizes an actuator assembly having a roller screw assembly which upon activation, displaces a ram member which in turn actuates a jaw assembly. FIG. 1 illustrates a tool 10 having a jaw assembly 30 which can be selectively opened and closed as described herein. Typically, the jaw assembly 30 can be attached to, and removed from the tool 10. However, the present subject matter includes crimping tools in which the jaw assembly 30 is generally not disengageable from the tool 10. Furthermore, although in many embodiments the crimping tool is electrically powered, the present subject matter also includes tools that are hydraulically powered, pneumatically powered, and/or manually powered. Moreover, although the crimping tool 10 is described as utilizing a roller screw assembly, it will be understood that the present subject matter includes tools utilizing a variety of mechanisms for powering or advancing a ram member and/or closing the jaw assembly. Although the present subject matter tools are typically battery powered, it will be understood that the tools can include cords for transmitting electrical power to the tool. Such corded tools would typically not include a battery. Alternatively, such battery-free tools may simply include a port or other receptacle at which electrical power is provided.

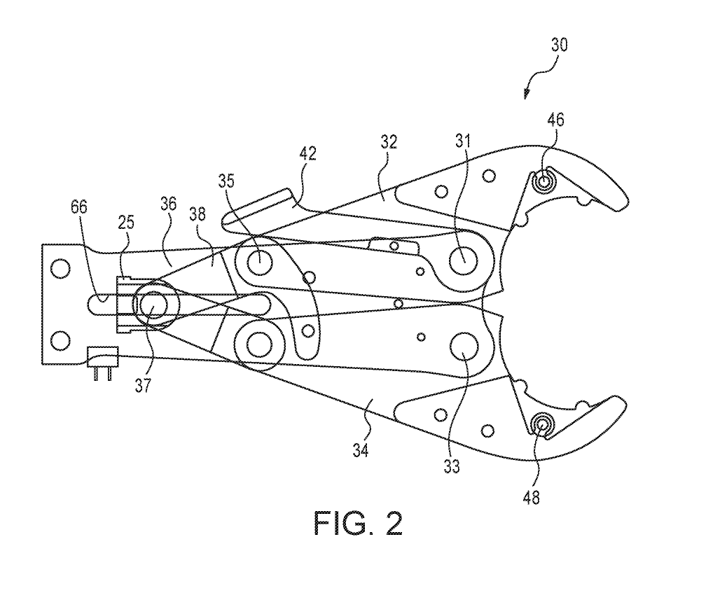

Referring to FIG. 2, a schematic partial cross sectional view of an embodiment of a jaw assembly 30 in accordance with the present subject matter is illustrated. FIG. 2 illustrates a jaw assembly 30 comprising a first jaw 32, a second jaw 34, and a jaw frame 36 to which each jaw 32, 34 is pivotally coupled by jaw pins 31 and 33, respectively. The jaw assembly 30 also comprises a linkage assembly that includes a cam linkage member 38 which is pivotally affixed to the jaw 32 by a jaw pin 35, and pivotally affixed to a clevis assembly 125 by a jaw pin 37. The clevis 25 is linearly displaced along or within a guide slot 66 upon actuation of a motor and roller screw assembly (not shown). The guide slot 66 is defined within one or more frame members such as the frame member 36 of the jaw assembly 30.

In many embodiments, the jaw assembly 30 also comprises a lever 42 that is pivotally supported at the jaw pin 31 of the first jaw 32. The lever 42 is positioned and configured to selectively contact a region of the cam linkage member 38, as described in greater detail herein. After performing a crimping or clinching operation such that the jaws 32, 34 are in a closed position, a user can easily open the jaws 32, 34 by pressing the lever 42. Pressing the lever 42, applies a rotational moment to the cam linkage member 38, which in turn linearly displaces the clevis 25 to move away from the jaws 32, 34, thereby opening the jaws. A user can grip a workpiece such as plastic tubing and/or a fitting with one hand and engage the fitting with the tool to complete the crimp with the other hand. A typical hand position when operating a tool 10 in accordance with the present subject matter is depicted in FIG. 1 with a user's thumb positioned on the lever 42 and forefinger at a trigger position or other convenient location. As shown in FIGS. 1 and 2, a user's thumb can be used to depress the lever 42, rotate the cam linkage member 38 about the cam pivot pin 35, and open the jaws 32, 34 to engage a fitting (not shown) before a crimp or clinch is made. A lever spring biases the lever 42 so that contact is maintained between the cam linkage member 38 and the lever 42 through a range of travel of the jaw 32. It will be appreciated that the present subject matter tools can utilize a wide array of other biasing members to bias the lever 42, instead of or in addition to the lever spring. Furthermore, it will be understood that the present subject matter includes jaw assemblies that are free of any such biasing member(s).

In many embodiments, the jaw assembly such as jaw assembly 30 shown in FIG. 2 includes one or more protruding members 46, 48 that project from a working face of one or both jaws, preferably both jaws, and which are configured to engage corresponding recesses or receiving regions in one or more die sets, described herein. In a particular version, the jaw 32 includes a plurality of such protruding members 46, and the jaw 34 includes a plurality of such protruding members 48. In certain embodiments, each jaw includes two protruding members each extending from opposite faces of the jaw. The protruding members provide support for the die sets to react against forces exerted on the dies during a crimping or clinching operation. In a particularly preferred version, the protruding members 46, 48 are configured to react exclusively against all forces exerted on the dies during a crimping operation and thus no such forces are exerted upon a pin(s) or other retaining member(s) utilized to attach or affix the dies to the jaws 32, 34 in an unloaded state.

Additional details and description of the tool 10, the jaw assembly 30, and operation of the tool 10 and jaw assembly 30 are provided in US applications U.S. Ser. No. 15/379,105 filed Dec. 14, 2016; and U.S. Ser. No. 15/429,978 filed Feb. 10, 2017. It will be appreciated that in no way is the present subject matter limited to the particular tool 10 and/or the jaw assembly 30 described and illustrated. Instead, the present subject matter includes the use of a variety of different tools and/or jaw assemblies.

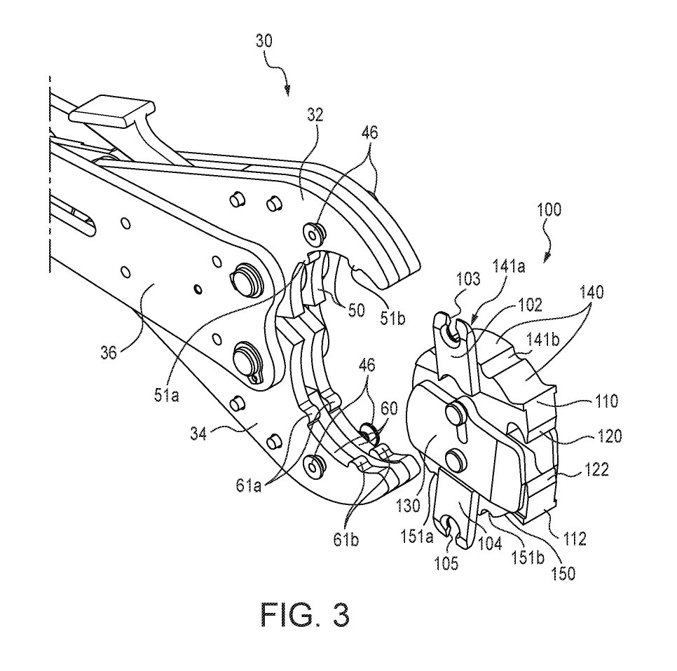

FIG. 3 illustrates an embodiment of a tool system in accordance with the present subject matter comprising a jaw assembly 30 (powered and/or actuated by the tool 10 not shown in FIG. 3) and a clinch-type die set 100. The die set 100 includes at least one, and typically two or more engagement wings such as wings 102 and 104. Each wing defines a receiving region sized and shaped to receively engage a corresponding member 46, 48. Specifically, the engagement wing 102 defines a receiving region 103 and the engagement wing 104 defines a receiving region 105. The die set 100 also includes two and typically a pair of die members 110, 112. At least one of the die members 110, 112 is movably retained within a frame 130 of the die set 100. Typically each die member 110, 112 is affixed to a corresponding wing 102, 104. Defined at a distal end of each die member 110, 112 is a corresponding projecting clinch region 120, 122 adapted for engagement with a clinch-type fitting. Additional details of the clinch-type die set 100 are provided herein. In FIG. 3, the jaw assembly 30 is shown in an opened position in which the jaws 32, 34 are positioned relative to each other such that the die set 100 can be positioned between the jaws and engaged therein at the members 46 and 48.

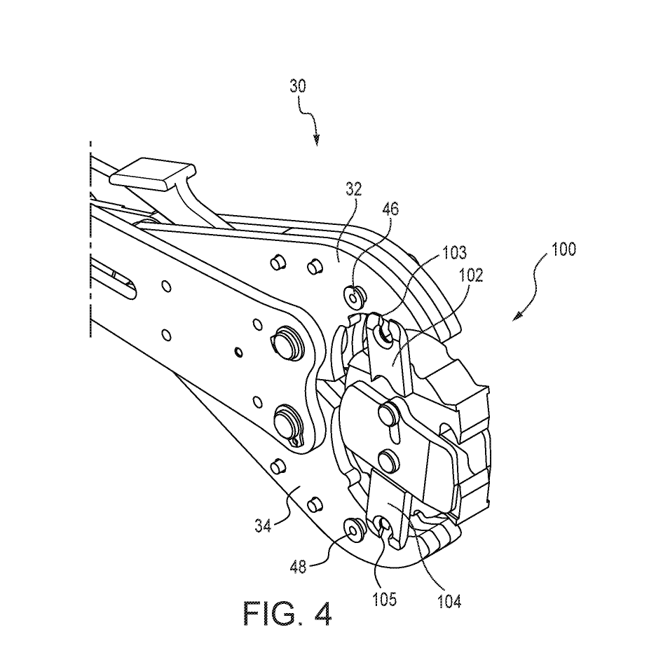

FIG. 4 illustrates the tool system depicted in FIG. 3 in which the clinch-type die set 100 is positioned within the jaw assembly 30 and at least partially between the jaws 32, 34. The die set 100 is not engaged in the jaw assembly 30 at this position since engagement wings 102 and 104 are not secured to the members 46, 48.

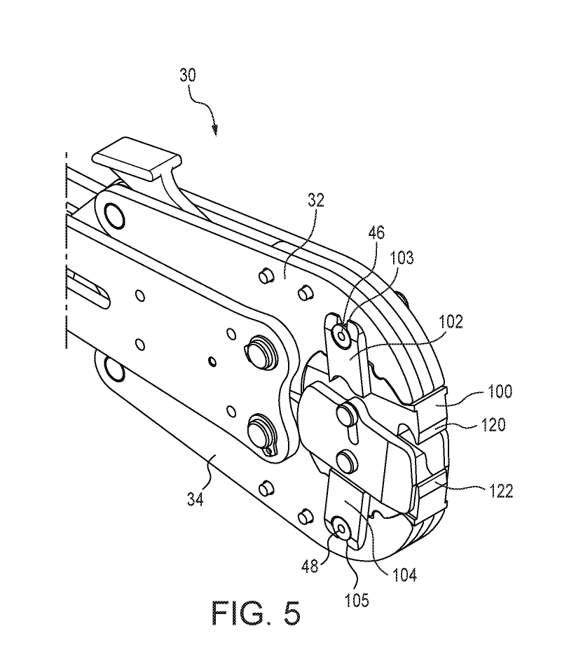

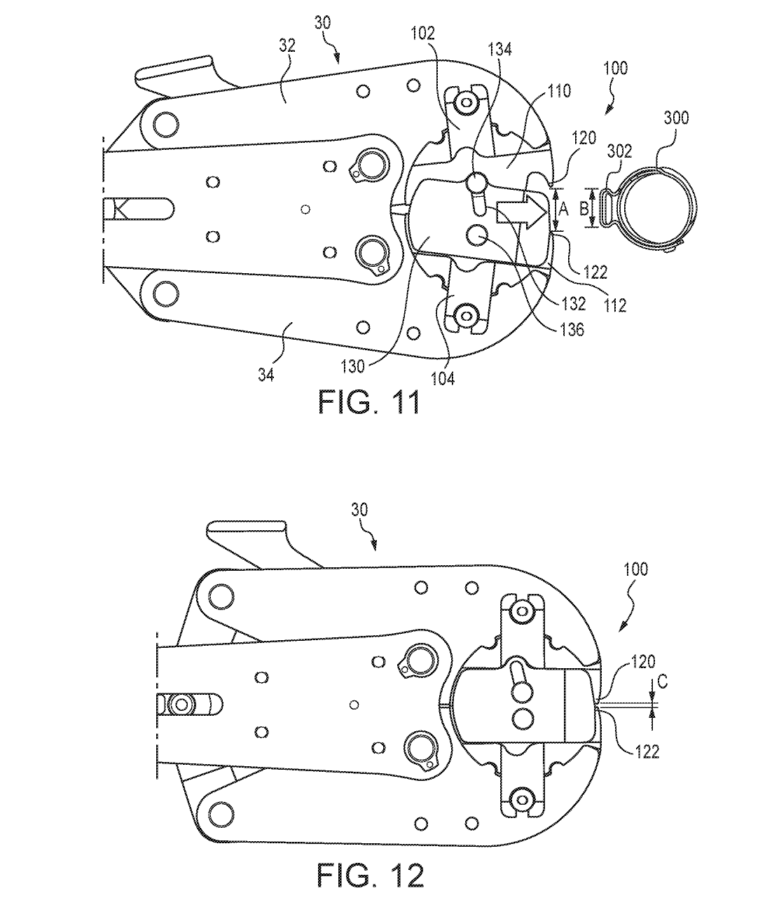

FIG. 5 illustrates the tool system depicted in FIGS. 3 and 4 in which the clinch-type die set 100 is positioned within the jaw assembly 30 and between the jaws 32, 34. The die set 100 is engaged in the jaw assembly 30 at this position since the engagement wing 102 is releasably secured to the member 46 by placement of the member 46 within the region 103, and the engagement wing 105 is releasably secured to the member 48 by placement of the member 48 within the region 105. FIG. 5 also illustrates the clinch-type die set 100 in an open position in which the clinch regions 120, 122 are spaced apart from each other. Additional aspects of this configuration are described in association with FIG. 11.

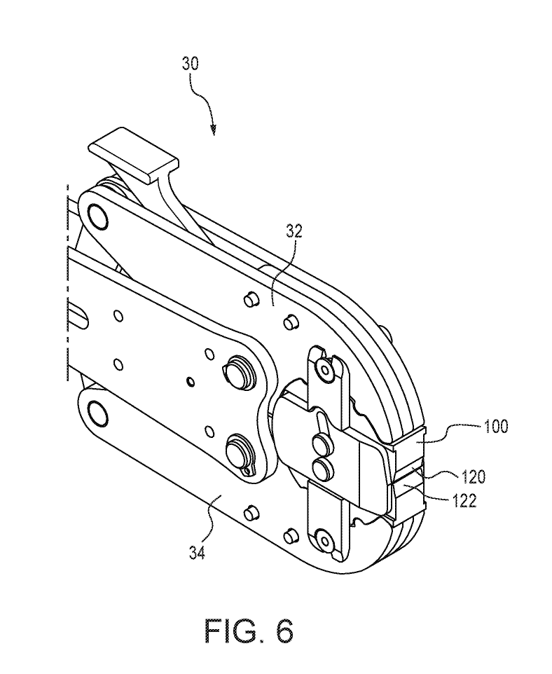

FIG. 6 illustrates the tool system shown in FIGS. 3-5 in which the clinch-type die set 100 is positioned within and engaged in the jaw assembly 30. The jaws 32, 34 are fully closed and the clinch-type die set 100 is also in a closed position at which the clinch regions 120, 122 are spaced apart from each other by a predetermined gap. Additional aspects of this configuration are described in association with FIG. 12.

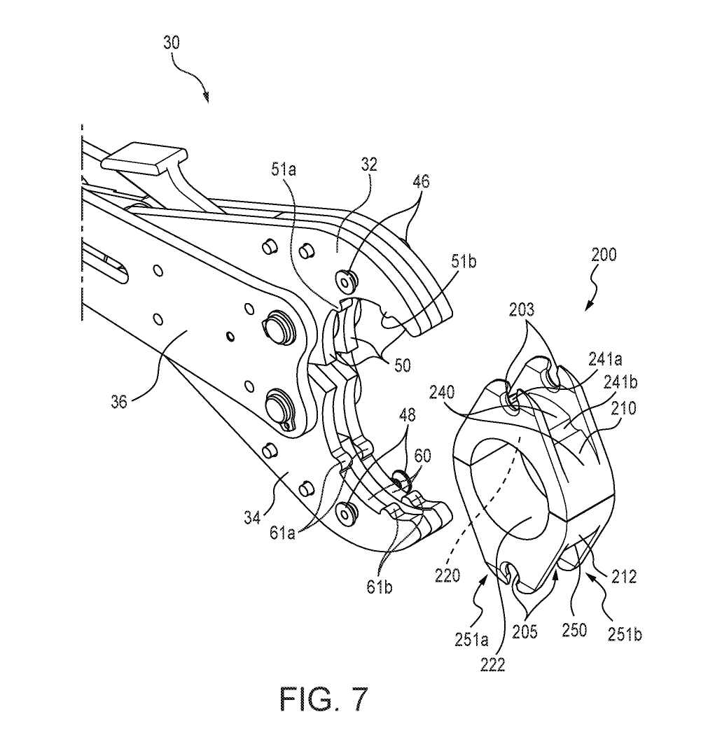

FIG. 7 illustrates the previously described jaw assembly 30 (powered and/or actuated by the tool 10 not shown in FIG. 7) and a radial press die set 200, in accordance with the present subject matter. The die set 200 includes at least one, and typically two die members 210, 212 that each define a generally half circular die surface 220, 222. Each die member 210, 212 defines one or more receiving region(s) sized and shaped to receivingly engage a corresponding member 46, 48. Specifically, the die member 210 defines a receiving region 203 and the die member 212 defines a receiving region 205. Additional details of the radial press die set 200 are provided herein. In FIG. 7, the jaw assembly 30 is shown in an opened position such that the die set 200 can be positioned therein at the members 46, 48.

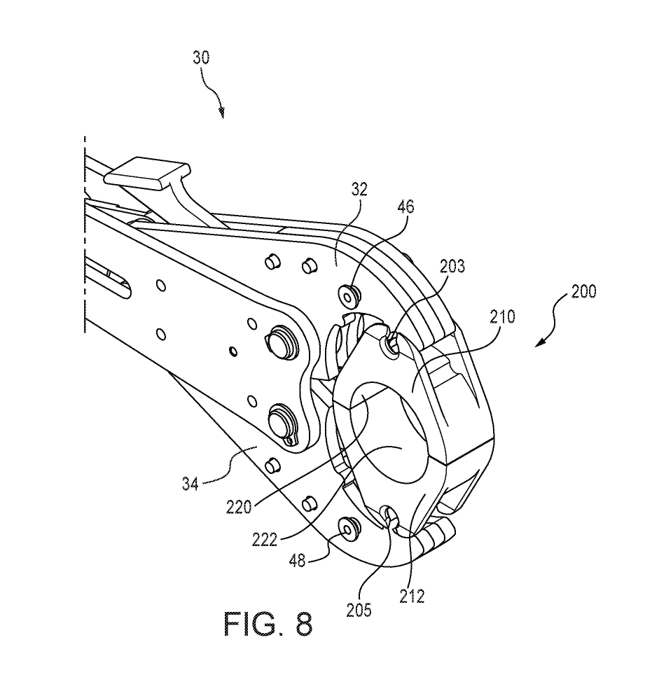

FIG. 8 illustrates the tool system shown in FIG. 7 in which the radial press die set 200 is positioned within the jaw assembly 30 and at least partially between the jaws 32, 34. The die set 200 is not engaged in the jaw assembly 30 at this position since the die members 210, 212 are not secured to the members 46, 48.

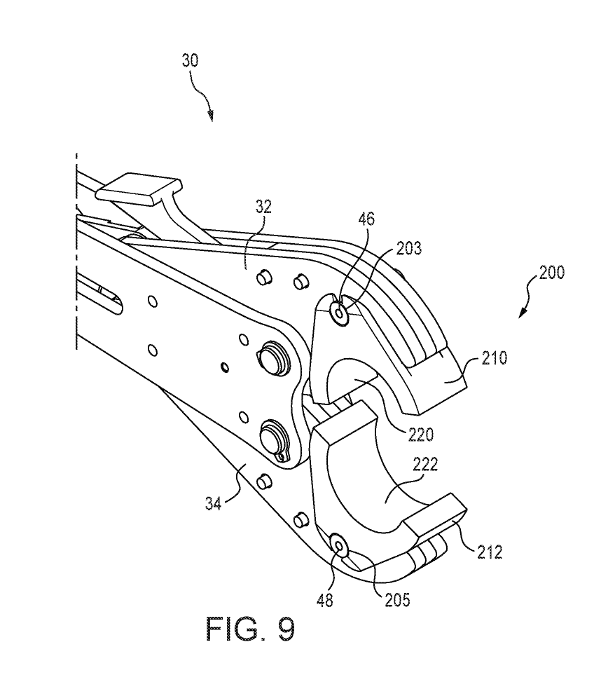

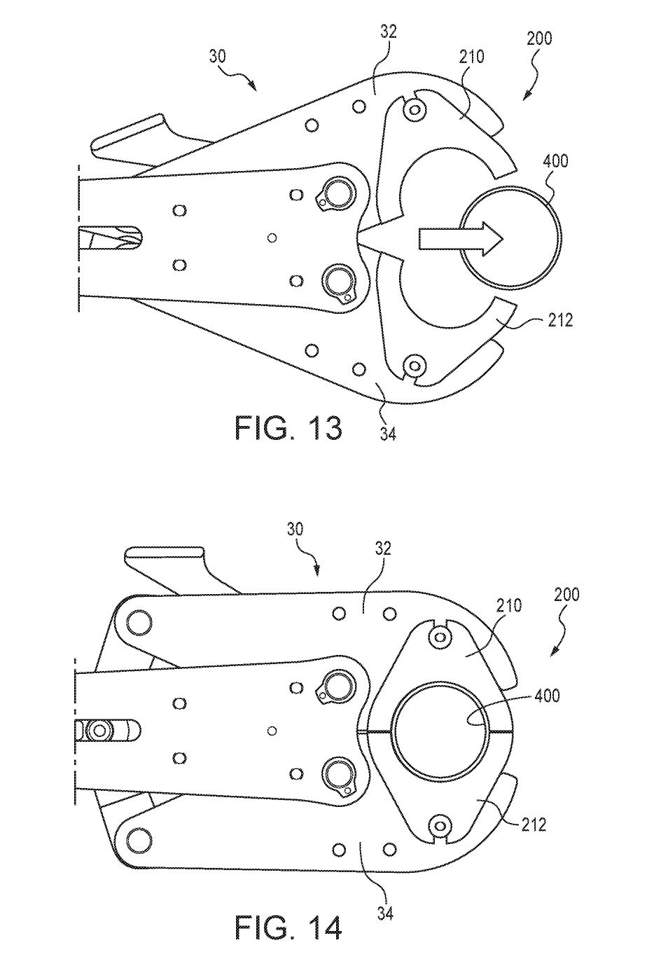

FIG. 9 illustrates the tool system shown in FIGS. 7 and 8 in which the radial press die set 200 is positioned within the jaw assembly and between the jaws 32, 34. The die set 200 is engaged in the jaw assembly 30 at this position since the die member 200 is releasably secured to the member 46 by placement of the member 46 within the region 203, and the die member 212 is releasably secured to the member 48 by placement of the member 48 within the region 205. FIG. 9 also depicts the radial press die set 200 in an open position in which the die members 210, 212 are spaced apart from each other. Additional aspects of this configuration are described in association with FIG. 13.

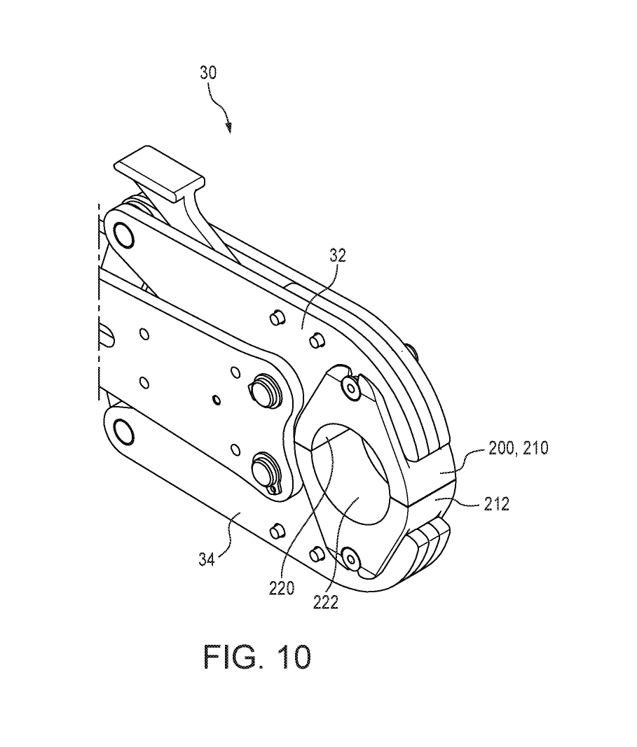

FIG. 10 illustrates the tool system shown in FIGS. 7-9 in which the radial press die set 200 is positioned within and engaged in the jaw assembly 30. The jaws 32, 34 are fully closed and the die set 200 is also in a closed position at which the die members 210, 212 contact each other such that the die surfaces 220, 222 form a generally circumferential surface. Additional details are provided in FIG. 14 and description herein.

In many versions of the tool systems of the present subject matter, the receiving regions provided by the radial press die set and the clinch-type die set are identical to each other. This feature enables both sets of die sets to be engaged with the same jaw assembly. For example, the receiving region 103 of the clinch-type die set 100 is the same or substantially the same as either of the receiving regions 203 of the radial press die set 200. In this regard, the term “same” refers to each receiving region, e.g., 103 and 203, having the same shape and size so as to receive and fittingly engage a protruding member of the jaw assembly. A similar relationship exists with regard to receiving regions 105 and 205 of the die sets 100, 200, respectively.

In accordance with the present subject matter, the tool systems enable the use of either of the radial press die set or the clinch-type die set to be used directly within a jaw assembly without the use of any adapters. This feature reduces the number of components which promotes ease of use and reduces costs of the tool system.

In many embodiments, the outer contours of both the radial press die set and the clinch-type die set include similar or identical contours or structures. This feature enables either of the die sets to be used in association with a single jaw assembly and/or press tool. In addition, this feature enables the use of either of the die sets without any adapters. Referring to FIGS. 3 and 7, the jaw assembly 30 may include one or more prominences provided along a jaw interior face. For example, the jaw 32 can include first and second prominences 51a and 51b along a jaw interior face 50. And, the jaw 34 can include first and second prominences 61a and 61b along a jaw interior face 60. The clinch-type die set 100 defines a first outer contour 140 which is shaped so as to fittingly engage the shape of the jaw face 50 of the jaw 32. The die set 100 also defines a second outer contour 150 which is shaped so as to fittingly engage the shape of the jaw face 60 of the jaw 34. Similarly, the radial press die set 200 defines a first outer contour 240 which is shaped so as to fittingly engage the shape of the jaw face 50 of the jaw 32. The die set 200 also defines a second outer contour 250 which is shaped so as to fittingly engage the shape of the jaw face 60 of the jaw 34. Each of the outer contours of the noted die sets includes a corresponding number of troughs or recessed regions that are sized and shaped and appropriately located along an outer contour such that upon placement and engagement of a die set with the jaw assembly, each trough receives and is fittingly engaged with a corresponding prominence. Thus, with continued reference to FIGS. 3 and 7, the outer contour 140 of the die set 100 includes a first trough 141a for receiving the prominence 51a and a second trough 141b for receiving the prominence 51b. The outer contour 150 includes a first trough 151a for receiving the prominence 61a and a second trough 151b for receiving the prominence 61b. The outer contour 240 of the die set 200 includes a first trough 241a for receiving the prominence 51a and a second trough 241b for receiving the prominence 51b. The outer contour 250 includes a first trough 251a (not shown) for receiving the prominence 61a and a second trough 251b (not shown) for receiving the prominence 61b. It will be appreciated that in many embodiments, the outer contours and/or troughs are formed in the die members of a respective die set.

FIGS. 11 and 12 illustrate a particular embodiment of a tool system utilizing a clinch-type die set 100 in accordance with the present subject matter. FIG. 11 shows the die set 100 engaged in the previously described jaw assembly 30 and the die set 100 positioned toward a clinch-type fitting ring 300. In this embodiment, the die set 100 is configured such that the wings 102, 104 and corresponding die members 110, 112 can be separated by a maximum opening span A such that the clinch regions 120, 122 are also separated from each other by a distance that is slightly greater than the maximum span B of an ear 302 of the ring 300. In many versions, span A is within a range of from 101% to 120% of span B. The frame 130 of the clinch-type die set may include a guide slot 132 within which a connecting member 134 may travel as the jaws 32, 34 are opened and closed. The connecting member 134 is affixed to the wing 102 and/or the die member 110. A corresponding connecting member 136 is affixed to the wing 104 and/or the die member 112. Opening of the die members 110, 112 is limited by the connecting member 134 reaching an end of the guide slot 132. It will be appreciated that the present subject matter is not limited to any of these particular details. By limiting the maximum opening span A of the die set 100, radial engagement of the clinch-type fitting ring 300 is simplified for a user. Excessive clearance between the die members 110, 112 and the ear 302 of the ring 300 would promote errors in alignment and faulty or improper clinching operations.

FIG. 12 depicts the jaw assembly 30 and clinch-type die set 100 of FIG. 11 in a closed position. In this embodiment, the clinch regions 120, 122 are spaced apart from each other by a closure span C. The closure span C is a predetermined gap that is designed to set the final dimension of the clinch-type fitting ring 300. This span C is typically checked over the life of the tool system using a “go/no-go” gauge as known in the art.

FIGS. 13 and 14 further illustrate the tool system utilizing a radial press die set 200 to crimp a radial press fitting ring 400 in accordance with the present subject matter. FIG. 13 shows the jaws 32, 34 and die members 210, 212 in a fully opened position. FIG. 14 shows the jaws 32, 34 and die members 210, 212 in a closed position. As compared to clinch-type die set 100 depicted in FIGS. 11 and 12, the radial press die set 200 allows the jaws 32, 34 to open to the fullest extent possible. This enables the opened die set 200 to easily radially engage the fitting ring 400.

The present subject matter also provides methods of forming sealed connections using different types of fittings or workpieces. In many embodiments, the methods form sealed connections between flexible tubing such as PEX tubing, and a fitting or other component as noted herein. The methods involve providing a tool system including a jaw assembly, a clinch-type die set adapted for placement and engagement between the jaws of the jaw assembly, and a radial press die set also adapted for placement and engagement between the jaws of the jaw assembly. The methods also comprise identifying an end of the flexible tubing to be sealingly connected to the component. The methods also comprise selecting one of (i) a clinch-type fitting ring and (ii) a radial press fitting ring. The methods then comprise positioning the end of the tubing over the component to which the tubing is to be sealingly connected. The methods additionally comprise placing the selected fitting ring over the tubing at or proximate the end of the tubing. The methods further comprise selecting one of the die sets of the tool system based upon the selection of the fitting ring. The methods also comprise engaging the selected die set with the jaw assembly of the tool system. If the selected fitting ring is a radial press fitting ring, the selected die set is the radial press die set, and the method further comprises positioning the jaw assembly and radial press die set such that the radial press die set is disposed about the radial press fitting ring, and urging the jaw assembly toward a closed position whereby the radial press fitting ring is deformed about the tubing to thereby form the sealed connection. If the selected fitting ring is a clinch-type fitting ring, the selected die set is the clinch-type die set, and the method further comprises positioning the jaw assembly and clinch-type die set such that the clinch-type die set is engaged with the clinch-type fitting ring, and urging the jaw assembly toward a closed position whereby the clinch-type fitting ring is tensioned about the tubing to thereby form the sealed connection.

Although the present subject matter has been described in terms of die sets for clinching or crimping a workpiece, fitting, or sealing ring, it will be understood that the present subject matter includes the use of other die sets which are adapted for compressing, deforming, or otherwise applying force to a workpiece, fitting, or sealing ring.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A tool system comprising:
a pivotally positionable jaw assembly including a first jaw and a second jaw, the jaw assembly positionable between an opened position and a closed position;
a clinch-type die set adapted for placement and engagement between the first jaw and the second jaw;
a radial press die set adapted for placement and engagement between the first jaw and the second jaw.

2. The tool system of claim 1 wherein the clinch-type die set includes:
a frame;
a pair of die members, at least one of which is movably retained within the frame, wherein each die member defines a projecting clinch region at a distal end of the corresponding pair of die members.

3. The tool system of claim 2 wherein upon the jaw assembly being positioned to the closed position, the clinch regions are spaced apart from each other by a closure span.

4. The tool system of claim 2 wherein upon the jaw assembly being positioned to the opened position, the clinch regions are spaced apart from each other by a maximum opening span.

5. The tool system of claim 2 wherein the clinch-type die set further includes:
a first wing affixed to one of the die members of the pair of die members, and a second wing affixed to the other of the die members of the pair of die members.

6. The tool system of claim 5 wherein the first jaw includes a first protruding member and the second jaw includes a second protruding member, and the first wing is releasably engageable with the first protruding member and the second wing is releasably engageable with the second protruding member.

7. The tool system of claim 1 wherein the radial press die set includes:
a first die member; and
a second die member.

8. The tool system of claim 7 wherein the first die member defines a generally half circular first die surface, and the second die member defines a generally half circular second die surface.

9. The tool system of claim 8 wherein upon the jaw assembly being positioned to the closed position, the first and second die members contact each other and the first and second die surfaces form a generally circumferential surface.

10. The tool system of claim 1 further comprising:
an actuator assembly including a displaceable ram and provisions for releasably engaging the jaw assembly.

11. The tool system of claim 10 wherein the actuator assembly further includes a roller screw assembly.

12. The tool system of claim 11 wherein the actuator assembly includes an electric motor.

13. The tool system of claim 1 wherein the first jaw defines an interior jaw face and the second jaw defines an interior jaw face, both the clinch-type die set and the radial press die set defining a first outer contour that is shaped to fittingly engage the interior jaw face of the first jaw, both the clinch-type die set and the radial press die set also defining a second outer contour that is shaped to fittingly engage the interior jaw face of the second jaw.

14. The tool system of claim 13 wherein the first jaw further defines at least one prominence along the interior jaw face of the first jaw, and both the clinch-type die set and the radial press die set define at least one trough that fittingly engages the prominence.

15. The tool system of claim 14 wherein the second jaw further defines at least one prominence along the interior jaw face of the second jaw, and both the clinch-type die set and the radial press die set define at least one trough that fittingly engages the prominence.

16. A tool system comprising:
a tool having an actuator, and a jaw assembly including a first jaw and a second jaw, wherein the first jaw and the second jaw are positionable between an opened position and a closed position;
a radial press die set adapted for placement and engagement between the first jaw and the second jaw;
a clinch-type die set including a first movable member and a second movable member, each of the first and second movable members defining a clinch member at a distal end of a corresponding movable member, the die set adapted for placement and engagement between the first jaw and the second jaw, wherein upon placement and engagement of the clinch-type die set with the jaw assembly, and positioning the first and the second jaws to the opened position, the clinch members are spaced apart from each other, and upon positioning the first and the second jaws to the closed position, the clinch members are spaced apart from each other by a closure span.

17. The tool system of claim 16 wherein the radial press die set includes:
a first die member; and
a second die member.

18. The tool system of claim 17 wherein the first die member defines a generally half circular first die surface, and the second die member defines a generally half circular second die surface.

19. The tool system of claim 18 wherein upon the jaw assembly being positioned to the closed position, the first and second die members contact each other and the first and second die surfaces form a generally circumferential surface.

20. The tool system of claim 16 wherein the actuator further includes a roller screw assembly.

21. The tool system of claim 16 wherein the actuator includes an electric motor.

22. The tool system of claim 16 wherein the first jaw defines an interior jaw face and the second jaw defines an interior jaw face, both the clinch-type die set and the radial press die set defining a first outer contour that is shaped to fittingly engage the interior jaw face of the first jaw, both the clinch-type die set and the radial press die set also defining a second outer contour that is shaped to fittingly engage the interior jaw face of the second jaw.

23. The tool system of claim 22 wherein the first jaw further defines at least one prominence along the interior jaw face of the first jaw, and both the clinch-type die set and the radial press die set define at least one trough that fittingly engages the prominence.

24. The tool system of claim 23 wherein the second jaw further defines at least one prominence along the interior jaw face of the second jaw, and both the clinch-type die set and the radial press die set define at least one trough that fittingly engages the prominence.

25. A method for forming a sealed connection between flexible tubing and a component, the method comprising:
providing a tool system including (i) a pivotally positionable jaw assembly including a first jaw and a second jaw, (ii) a clinch-type die set adapted for placement and engagement between the first jaw and the second jaw, and (iii) a radial press die set adapted for placement and engagement between the first jaw and the second jaw;
identifying an end of the flexible tubing to be sealingly connected to the component;
selecting one of (i) a clinch-type fitting ring and (ii) a radial press fitting ring;
positioning the end of the tubing over the component to which the tubing is to be sealingly connected;
placing the selected fitting ring over the tubing at or proximate the end of the tubing;
selecting one of the die sets of the tool system based upon the selection of the fitting ring;
engaging the selected die set with the jaw assembly of the tool system;
wherein if the selected fitting ring is a radial press fitting ring, the selected die set is the radial press die set, and the method further comprises positioning the jaw assembly and radial press die set such that the radial press die set is disposed about the radial press fitting ring, and urging the jaw assembly toward a closed position whereby the radial press fitting ring is deformed about the tubing to thereby form the sealed connection;
wherein if the selected fitting ring is a clinch-type fitting ring, the selected die set is the clinch-type die set, and the method further comprises positioning the jaw assembly and clinch-type die set such that the clinch-type die set is engaged with the clinch-type fitting ring, and urging the jaw assembly toward a closed position whereby the clinch-type fitting ring is tensioned about the tubing to thereby form the sealed connection.

26. The method of claim 25 wherein urging the jaw assembly toward the closed position is performed by an actuator engaged with the jaw assembly.

27. The method of claim 26 wherein the actuator includes an electric motor.
